(19) United States
(12) Patent Application Publication
(10) Pub. No.: US 2006/0123059 A1
(43) Pub. Date: Jun. 8, 2006

(54) Method for organizing a digital database in a traceable form

(76) Inventor: Michel Zamfiroiu, RUEL-MALMAISON (FR)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/527,516

(22) PCT Filed: Sep. 9, 2003
(86) PCT No.: PCT/FR03/02675

§ 371 Date: May 13, 2005

(30) Foreign Application Priority Data
Sep. 11, 2002 (FR) 02/11250

(51) Int. Cl. G06F 17/30

(52) U.S. Cl. 707/200

(57) ABSTRACT

A process for organizing a digital database in a traceable form including modifying a main digital database by addition or deletion or modification of a recording of the main database, wherein modifying the main database includes creating at least one digital recording including at least unique digital identifiers of concerned recordings and attributes of the main database, a unique digital identifier of a state of the main database corresponding to the modification of the main database, elementary values of attributes assigned via elementary operations without proceeding to store non-modified attributes or recordings, and addition of the concerned recording in an internal historical database composed of at least one internal historical table, and reading the main database, wherein reading relates to any final or previous state of the main database and includes receiving or intercepting an original request associated with the unique identifier of a target state in proceeding to a transformation of an original request to construct a modified request for addressing the historical database including criteria of the original request and the identifier of the target state, and reconstruction of the recording or recordings corresponding to the criteria of the original request and to the target state, wherein the reconstruction includes finding elementary values contained in the recordings of the historical database and corresponding to the criteria of the original request to reduce requirements of storage capacity and processing times.

The present invention relates to the area of managing persistent data of an entity, e.g., a company. In particular, the present invention relates to the follow-up of this persistent data in a database by a system for database management. It is, in fact, difficult for a company to guarantee the follow-up of the development process of strategic persistent data because this follow-up has several objective obstacles:

The asynchronous and collaborative nature of the development of the process,

The very demanding nature of the follow-up for constituting a real guarantee: the presence of one weak link definitively compromises the reliability of any response,

The non-availability of generic solutions for taking charge of the traceability in the software layers on the market at a satisfactory level of granularity: OS, DBMS [database management system], development language,

The very high cost of rewriting existing applications and the very high cost of taking explicit account of the traceability by each application.

The prior art already known a process for the identification and follow-up of the developments of a set of software components from international patent application WO 9935566. The process proposed by this document of the prior art allows the recording of the components by their name and their version. This classification at the file level does not respond to the problem of saving traces of data in a continuous manner, that is, at each modification of this data. In particular, the process proposed is not suitable for tracing a database modified at each write access.

U.S. Pat. No. 5,347,653 proposes a method supplying a historical perspective of a database of stored objects by means of a versioning of the objects stored as well as an indexing representative of the objects. This method of the prior art proposes integrally storing the last version of the database and on the other hand storing the differences to be applied to this last version in order to obtain previous versions. The problem posed by this document is the necessity of applying the differences one by one and in series in order to find the state of the base at a given date. This constraint implies a significant expense of time.

Likewise, patent application PCT WO 02/27561 (Oracle) in the prior art teaches a system and a process for furnishing access to a time division database. The invention described in this document concerns a system and a process for selectively viewing data in temporary rows in a constant reading database. The saved transactions causing changes in the data in the rows of a database are tracked and a change number of the system stored is assigned to each saved transaction. A requested selection of the values of data in the rows of the database is executed as well as an inquiry time taking place before the saving time of at least one saved transaction. The values of the data in ordered rows contained in the cancellation segments storing a transaction identifier for at least one saved transaction are recovered.

Patent application PCT WO 92/13310 (Tandem Telecommunication Systems) from the state of the art also teaches a process for the selection and representation of data varying in time from a management system for a database developing as a function of time, which process produces a unified view on a computer screen. The data coming from a master recording relative to a particular entity is displayed with a video attribute or by character by default and is considered as being the up-to-date recording. The access to a recording that is historical relative to this entity brings it about that the data relative to the fields that differ from the corresponding fields of the up-to-date recording is superposed on such fields of up-to-date recording but with a video attribute or by a character different from the video attribute or by the character by default. The superposed up-to-date recording becomes a new up-to-date recording intended for other superpositionings. In the same manner, the access to a held recording brings it about that the data relative to the fields that differ from the corresponding fields of the up-to-date recording is superposed on such fields of up-to-date recording but with a video attribute or by a character different from the video attribute or by the character by default. A plurality of historical or held recordings can be composed in such a manner that all the modified fields for a recording set from the end of a defined period can be superposed on an up-to-date recording at one time.

European patent application EP 0 984 369 (Fujitsu) also teaches a mechanism for storing dated versions of data. In this storage mechanism the data is stored as a plurality of recordings with each recording comprising at least one attribute, a time marker indicating the duration for which the attribute is valid, an insertion time indicating the moment at which the recording was created and a type field. The type field indicates whether the recording is a concrete recording, a delta recording or an archive recording replacing one or several archived recordings. Data is accessed in order to find an attribute value from the viewpoint of a “specified time” by realizing an extraction of the recordings that have insertion times prior to the “specified time” and constructing an attribute value from the extracted recordings. The data is updated solely by adding concrete or delta recordings without modifying the attribute values in the concrete or the delta recordings.

The present invention proposes to eliminate the disadvantages of the prior art by proposing a process for the follow-up of the development of the data in an architecture based on an DBMS, consisting of:

The materialization of the intermediate versions and of data streams resulting from operations performed on the database as its development proceeds at the level of elementary granularity (recording by recording and attribute by attribute);

The possibility of “rapid” reconstitution and retrieval of every original historical framework state of each data version and each operation (we understand by the term “rapid” “without perceptible additional time connected to the restoration”); comprising:

Mechanisms for reconstituting the stream of causal dependence (of the source-destination type) between the data concerned;

Mechanisms for notifying the reappraisal of operations in the past in the case of the development of the input data;

Mechanisms of re-execution; and covering the following particular cases and extensions:

Taking account of the structural development (development of scheme);

Taking account of the development of applications;

Taking account of applications existing in a flexible architectural framework;

Schemes of gradual development of an architecture on the scale of the company;

Management of virtual versions (alternative families and parallel hypotheses).

The primary problem of the invention is to permit the exploitation of the base data in accordance with the successive versions while limiting the requirements of time and storage capacity and to authorize retrieval on the fly.

A customary step consists in recording successive versions of databases, e.g., in the form of periodic storing on a support such as a magnetic cartridge with the completeness of the database corresponding to the current version. The search for information requires the advance restoration of the entire base starting from the support corresponding to the corresponding backup, then the querying of the base restored in this manner. For bases of important data and such as those used in the banking system, the insurance system or management, the volume corresponding to a state can exceed a terabyte, a volume which it is advisable to multiply by the number of backed up states.

This solution is totally not adapted for use in real time.

The invention has the task of responding to the technical problem of using large-volume databases in real time.

To this end the invention concerns in its most general meaning a process for organizing a digital database in a traceable form comprising steps for the modification of a main digital database by the addition or deletion or modification of a recording of the main base and of the reading steps of the main database, characterized in that

The step of modifying the main database comprises an operation of creating at least one digital recording comprising at least:

The unique digital identifiers of the concerned recordings and attributes of the main database,

A digital identifier of the state of the main database corresponding to this modification of the main database,

The elementary values of the attributes assigned to them via elementary operations without proceeding to store non-modified attributes or recordings,

And the addition of this recording in an internal historization base composed of at least one internal historization table,

And in that the reading step relating to any final or previous state of the main database consists in receiving (or intercepting) an original request associated with the unique identifier of the state aimed at, in proceeding to a transformation of this original request in order to construct a modified request for addressing the historization base comprising the criteria of the original request and the identifier of the state aimed at, and the reconstruction of the recording or recordings corresponding to the criteria of the original request and to the state aimed at, which reconstitution step consists in finding the elementary values contained in the recordings of the historization base and corresponding to the criteria of the original request (in order to reduce the requirements of storage capacity and the processing times).

According to a variant these recordings of the historization database also contain references to other recordings of the internal database in order to specify the connections of dynamic dependence of the source-destination type constituting the causal stream of the interferences between the data versions.

This operation of modifying the main base is advantageously a logic operation and said operation of addition in the historization database consists in adding:

A recording identifying the state of the base corresponding to the logic operation,

As many recordings as parameters of the logic operation,

A recording for the possible result of the logic operation,

And specifying by cognateness the regrouping of operations from the elementary level of modification to the level of the transaction, passing the number of semantic levels necessary for the applications.

According to another variant the main database comprises one or several tables organizing the development links between the identifiers of the successive and alternative states of the main base and intended to organize the recordings of the internal database.

This table or tables of the development links between the states of the main base preferably contain(s) recordings specifying the rules of correspondence between the recordings of the internal historization database and the states of the main database.

According to a particular embodiment this reading operation consists in determining said state of the main database by referring to said identifiers and to the tables of development links between the states of the main base.

An application querying the main database can advantageously specify the state of the desired main database.

The invention also concerns an architecture for managing a database, characterized in that this application can bring about modifications in the entire state of the main base and give rise, in the instance of an attempt to modify a previous state, to the creation of new alternatives of digital development of the main database, whose data will be generated by the same internal historization database.

According to a variant the dependence links serve as recovery criteria for said operations already carried out.

The updatings carried out on the various branches can preferably be integrated or merged into the framework of a new state “inheriting” these branches.

According to a particular embodiment the cases of the development of the structure of the data of the main database are treated as particular cases of the development of the data of this base, however little the structure/scheme of this main base is described in the manner cited for the data, as a dictionary.

According to another embodiment the historization database is explored and queried by applications via the native mode of the DBMS in order to obtain information such as, e.g., all the historical values of an attribute and all the (dynamic) incidents of every updating and to navigate along the versions and the streams of dynamic dependence in a classic manner in accordance with the querying language in force required by the DBMS.

The present invention will be better understood with the aid of the following description, made purely by way of explanation, of an embodiment of the invention with reference made to the attached figures.

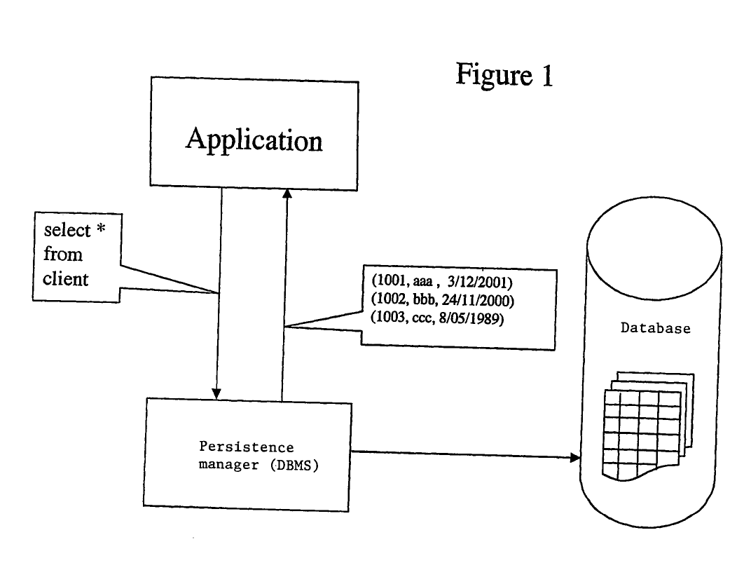

FIG. 1 shows a classic communication architecture between an application and a database.

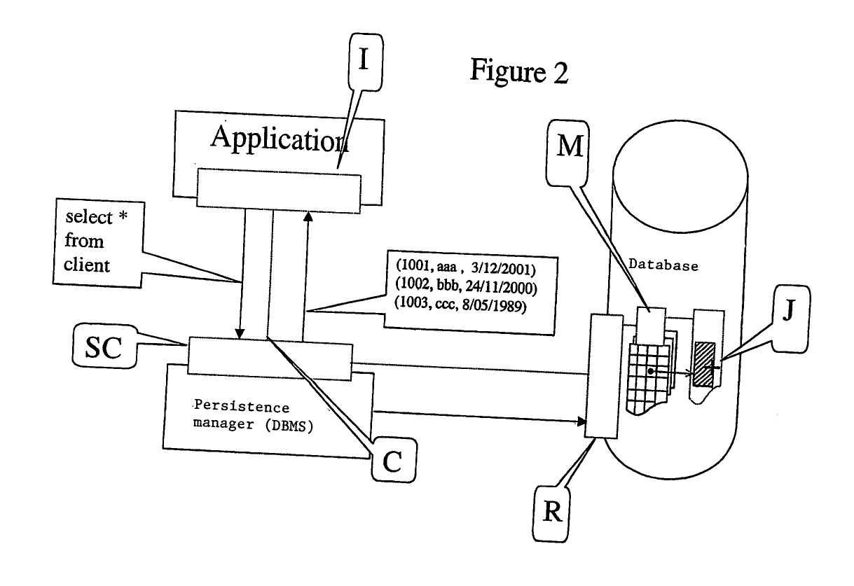

FIG. 2 shows a communication architecture similar to that of FIG. 1 and comprising the elements necessary for the application of the invention.

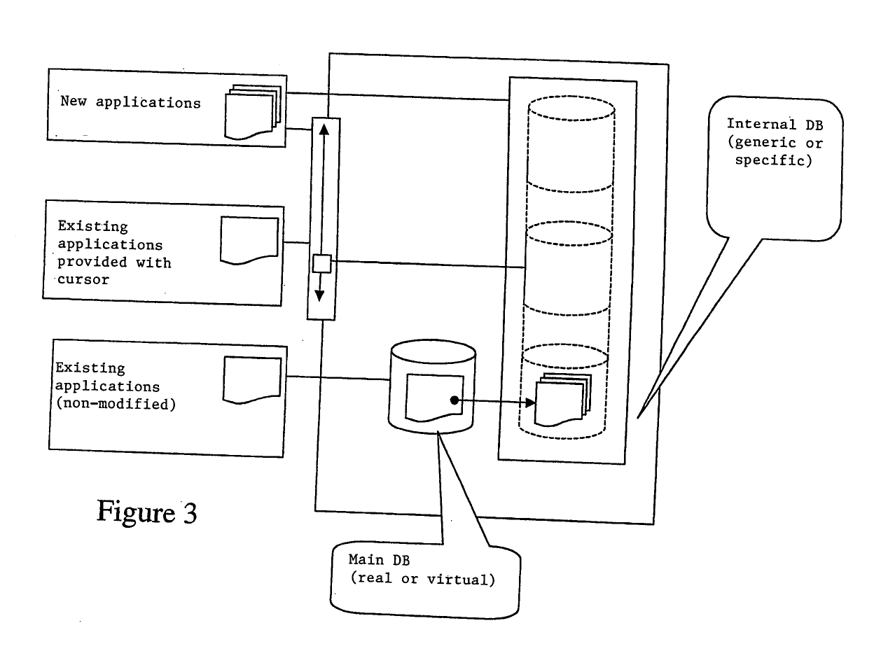

FIG. 3 shows the different means for accessing a database organized in a traceable manner and provided with a system in accordance with the invention.

The management of the persistent data of a company (or of an organization in the broad sense) is generally entrusted to a specific software also called a DBMS [database management system]. Computer applications propose interactive ergonomic means to the users that are capable of visualizing and developing the data of the database of the company by communicating with the DBMS. We will recall in the following paragraphs the main features of the architecture in order to position the framework of our process of the follow-up of the development of the data and to fix its minimum vocabulary.

The persistence manager necessary for out system authorizes the storing of data and its reconstitution in memory in conformity with its structure (defined as a set of attributes) and the values entered or calculated. The main relational DBMS'es (but also of the object, network or hierarchical type) on the market are good candidates for the role of persistence manager. Moreover, this compatibility is an ace of our process, that can also draw profit in this manner from the software base installed in the company.

Consider by way of simplification and solely by way of example the use of a relational DBMS. It permits the representation of data in the form of tables (or relations). The columns indicate the attributes (or fields). Each column is characterized by a domain (entire, character, date, floating, etc.) and by other possible information such as the maximal size (for chains of characters). Certain attributes (one or several) constitute the key or the identifier of the recording. The following figure shows a table indicating the keys (underlined). Each line of one and the same table represents a new recording (or n-uplet) of uniform structure. Each cell represents the value of the attribute. For example, “aaa” is the value of attribute Attribute1 of the first recording, whose key is 1001.

TABLE

| Key | Attribute 1 | Attribute2 |
|---|---|---|
| 1001 | “aaa” | 12/23/2001 |
| 1002 | “bbb” | 11/24/2000 |
| 1003 | “ccc” | 5/8/1989 |

The data is inserted, read, modified and deleted via a language for manipulating data (e.g., SQL [structured query language]).

The persistence manager also allows the definition, consultation and development of the data structure, also called data scheme. Thus, the tables can be defined, deleted or restructured. In the latter instance columns can be added or deleted. At times, it is even useful to change the domain of an attribute or of other analog characteristics, which can imply implicit or explicit conversion processes of the data concerned.

Whatever the physical representation of the data, the table is the logical reference for the representation of data. Thus, the applications generally “see” in the form of tables. It is important to emphasize that our system depends on preserving this logical representation in order to ensure the greatest compatibility with the existing applications. For example, after having requested the connection to a particular database, an application can address a persistence manager with a request of the “select * from client” and receive in exchange the data set permitting the reconstitution of the data in tabular form.

Finally, it is specified that a database represents a coherent state of the real world represented. The data of the base develop in surges released by events via the operations (insertion, updating or deletion) generally grouped by transactions. The latter are characterized by particular properties called ACID (atomicity, coherence, isolation and durability) that guarantee a certain level of quality.

Ensuring the traceability of persistent data amounts to supplying means that permit the follow-up upstream and downstream from the data development process.

The process of developing data is a generally non-predictable succession of executions of elementary operations that read, transform and write the data in a repeated manner giving rise most frequently to multiple and complex interferences that render their follow-up difficult and frequently impossible. Ensuring the traceability of the process amounts to being capable of going back at every moment to the origins (beginnings) of the process, finding the values of the original data, being able to follow and understand their consequences during the course of the operations in terms of the impact of changes. In terms of quality of the information, traceability is very valuable because it allows the conformity of the result of an operation applied with the input data set to be guaranteed.

In order to better understand the extend of its scope, a classification of traceability is presented according to progressively more advanced levels:

The first level of traceability, that can be qualified as elementary, is that of the representation and storage of data. It is therefore a matter of describing the structure, then of storing and identifying the data, whether it is a command, an article or even a mechanical component in order to be able to retrieve it later. This type of functionality is already ensured by specialized software called database management systems (DBMS). The development process is manifested by the successive application of elementary operations such as reading, insertion, updating and deletion. These elementary operations are generally grouped into transactions in order to maintain the coherence of the data under conditions of competing use or of recovery in case of breakdown. At this level, updates have as a natural consequence the loss of existing values as a consequence of their replacement by new values since, by convention, only one data (with its attributes) can correspond to one identifier. This first level of traceability that is called elementary is indispensable but largely insufficient.

The second level of traceability authorizes a data to have several versions (distinct values) at the same time. This improves the traceability since it becomes possible to have values preceding as well as values following the execution of an operation or a process at any moment, which facilitates even more the comprehension of the development. The versioning introduces a valuable quality since the irreversibility can no longer be bypassed (the development of data is allowed without loss of the current values). In addition to successive versions there are alternative versions. It frequently occurs that a user, after having traced back the chain of execution of a process, desires to make a few changes to the previous state of the data. In these instances the versioning mechanisms allow the taking into account of alternatives or of branches of development that authorize several possible continuations from the same state of the base. An advanced system of traceability should therefore integrate this aspect, all the more since a new branch allows the preceding ones not to be destroyed, thus preserving the traceability of previous processes. There are numerous works that take into account the data whose values develop in time. The domain of time-division databases clearly distinguishes the axis of the validity time from that of the transaction time. The validity time allows, e.g., the fact to be specified that a price is valid from one date to the next. This information is totally independent of the date of the updating of the data that stores it in the base and that is situated in the time called transactional. By virtue of the specific nature of their problems, the mechanisms for taking account of the validity time comprise solutions of querying and of updating (publication of R. Snodgrass, “The Temporal Query Language Tquel”, ACM Transactions on Database Systems, Association for Computer Machinery, New York, USA), propose operators dedicated to taking account of intervals (between, before, etc.), and specifically treat the cases of updating time intervals for a data that imply a merging or a division (European patent application EP 0 984 369 (Fujitsu)). Moreover, the representation and the displaying of different versions require for their part specific solutions (PCT patent application WO 92/13310 (Tandem Telecommunications Systems)) that facilitate the understanding of the development of individual data without being concerned with branches or of the global criterion of the collective coherence of the data of the base in the versioning space. In fact, these aspects are located outside of the problem of traceability, that has a number of requirements relating to versioning that are specific to it, and are still unresolved. Archiving and restoration are finally cited as mechanisms allowing the retrieval of previous states of the database. It is evident on the other hand that they are inadequate faced with the problem of traceability for reasons of too great a granularity in development follow-up, which creates insoluble disadvantages of response time and of storage space. In conclusion, versioning is also indispensable for ensuring traceability but still remains, as will be seen further below, insufficient.

A third level of traceability is that of operations. Tracing an operation amounts to allowing a persistent trace of the execution of this operation, permitting an even better understanding of the manner of how the data develops. In this manner the development of a command between two versions can be better explained if it is known, e.g., that there was a recovery operation for the total price. The majority of DBMS have journaling mechanisms that authorize the consultation of operations carried out at the elementary level. This information should be correlated with the high-level operations In order that it can be understood by the users. The basic problem here is that the journal entries do not have the same persistence cycle as the data. Thus, the journal is generally located outside of the database and is regularly purged by the administrator. PCT application WO 02/27561 (Oracle) brings an alternative solution to this problem by proposing the internal storage (in the database) of transactions and of information about the cancellation of their effects (undo), which allows every previous state of the database to be retrieved by executing in the inverse order the inverse of the operations that took place afterwards. Although interesting, this technique can be very cumbersome in terms of execution time because, in order to retrieve a precise version of a data, it undoes all the operations that took place afterwards, including those that do not concern it. Moreover, it is not appropriate either for obtaining the list of all the versions of a data. Finally, it prevents any updating from a previous state of the base, which separates the variants and the alternative branches of development. As will be seen later, in the present invention the inventors opted for the opposite strategy: Upon the receipt of a request, in the present invention its transformation is proceeded to then to an execution of the versioned data. Finally, note the necessity of having information of a higher level supplied, e.g., by the applications in order to obtain a connection between the semantics of the applications (application of a recovery upon a command) and that of the DBMS (updating of the attribute “amount” of the command).

The most advanced level of traceability is that of the causality. It concerns the materialization of the links for the transporting of information at the most elementary level (the finest grain). For example, if any operation O proceeds to read attribute A of data X, to read of attribute B of data Y, to the addition of the two and to the storage of the value obtained in this manner in attribute C of data Z, a causal link would be capable of reconstituting this transport of information through the different versions of the data X, Y and Z as well as to the various executions of operation O. This valuable information allows an understanding of the details of the developments and to transitively explain the origins of the modifications and detect the operations to be redone in case of a development of the original data. It is especially important because, contrary to the techniques of journaling, it rids itself of the sequential constraint of operations in order to concentrate on the dynamic dependencies caused by the causality. It is thus possible to become free of, e.g., thousands of operations, that do not interfere with the data that interests us. Finally, it turns out to also be extremely valuable for simplifying the merging of data located in different branches and for better identifying the true conflicts.

A particular case of development operation concerns the development of the scheme consisting in making the data structure develop without loss of information (Roddick 93—publication “A Taxonomy for Schema Versioning Based on the Relational and Entity Relationship Models”, J. F. Roddick, N. G. Craske and T. J. Richards, 1993). In a manner analogous to that of data, the follow-up of the development of its structure will be better ensured if the mechanism of versioning the follow-up of operations and causal traces also applies to the information describing the structure. Particular measures of organizing data and metadata (publication “Extracting Delta for Incremental Data Warehouse Maintenance”, P. Ram et al., Data Engineering, 2000) will be necessary.

One of the objectives of the present invention is to propose a low-intrusive and progressive process for organizing a digital database in a traceable form. We envisage ensuring the successive levels of traceability described above without, nevertheless, imposing a redevelopment of existing applications.

In other words, the objective pursued by the invention is to supply computer applications and their users with the ability to precisely follow data along its development by tracing their histories in a complete manner both at the individual level (intermediate versions and successor links) and at the collective level (trigger events and dynamic interdependence links from interactions among the data versions) by positioning it in the coherent framework of its original development.

It is thus a matter of supplying causality links to an elementary level at which it is possible to readily follow the causal stream of transformations and verify the validity of each intermediate operation under the input database of the treatment applied and of the resulting data in such a manner that the reconstitution of every state in the past is immediate.

In addition, the process in accordance with the invention makes use of a flexible architectural framework with the least possible amount of constraint and intrusion in order to supply a very broad applicability to the process proposed and the greatest possible compatibility with the processes of storage and manipulation of the current data.

In order to ensure the follow-up of the development of a database called “main”, the process of the invention allows one to proceed in such a manner that it represents not only one but all the necessary coherent, successive and/or alternative states of the real world represented in its development while preserving the ACID properties.

To this end the architecture implemented for the invention is illustrated in FIG. 2 and is constituted as follows:

A journal (J) organized in the form of an “internal historization database” constituted by a table or a set of tables dedicated to following up the development and based on a mode of universal storage with a stable scheme (independent of the logical representation of the applicative data) and particularly adapted to reconstituting data on the fly.

A monitor of transactions (M) and events capable of detecting every request for the development of values and structure transmitted to the database that progressively adds into the dedicated journal the entries characterizing the elementary development of data (identity, attribute, value, trigger event and dynamic dependencies).

A module for the reconstitution (R) on the fly of the state of the database according to a target event; the system is provided to this end with a cursor (C) dedicated to the selection of the sought state.

Particular case: In certain cases it can be useful to materialize the view of the base called “current” or “main” in the form of tables of specialized structure, e.g., in order to permit elevated performances and total compatibility with the existing applications (especially in order to permit the use of stored procedures and other triggers that an application might need in order to function correctly).

The architecture optionally also comprises:

A system for the follow-up of the conformity (SC) of applications with the states of the base and of its scheme,

Automatic inoculation tools (I) in the applications of instructions dedicated to the follow-up of dynamic dependencies (capture of data streams).

The journal (J) of events (or the internal historization database) is constituted primarily by a table with a structure independent of that of the applicative data. The columns are:

A unique identifier of the recording of the logical table concerned by the journal line belonging to the main key,

A universal event identifier incremented automatically and also belonging to the main key of the journal and corresponding to the state of the main base,

A value field dedicated to the storage of values.

The role of the monitor (M) is to detect and correctly interpret each development request while adding the corresponding information into the journal of events (J).

Examples of development of value

| | ID | Attribute | UEID | Value | Comments |
|---|---|---|---|---|---|
| insertion or | 110 | 0 | 52 | 53 | ID table |
| recording | | | | | “client” |
| updating of an | 110 | 1 | 853 | 1001 | Client No. |
| attribute | | | | | |
| updating of an | 110 | 2 | 854 | “aaa” | Client name |
| attribute | | | | | |
| Deletion of a | 110 | 0 | 981 | 0 | Deletion |
| recording | | | | | code |

In the language of exchange with an SQL database the first three lines of the table can be the effect of the following request:

insert into client (no_client, name_client) values (1001, “aaa”)

Such a request is processed as follows:

Syntactic analysis (parsing) of the request,

Recovery from the scheme of identifiers for the client table (53) as well as for the attributes “no_client” (1) [that is, “NO_client=client number] and “name_client” (2),

The last line can be obtained by the following instruction:

delete from client where no_client=1001

Such a request is processed as follows:

Syntactic analysis (parsing) of the request,

Recovery from the scheme of identifiers for the client table (53) as well as for the attribute “no_client” (1),

Recovery of the identifier of the recording of the journal with the value 1001 for attribute No. 1,

Insertion into the journal of the last line (using the code 0 for the value).

Examples of development of scheme

| | | | | | |
|---|---|---|---|---|---|
| Creation of a | | | | | |
| new table | ID | Attribute | UEID | Value | Comments |

Create table client (no_client int primary key)

| | | | | | |
|---|---|---|---|---|---|
| | 53 | 0 | 252 | 8 | ID table of |
| | | | | | the tables |
| | 53 | 1 | 253 | “client” | Table name |
| Adding of an | 54 | 0 | 254 | 9 | Name of |
| attribute | | | | | attribute |
| | 54 | 1 | 255 | “no_client” | Name of |
| | | | | | attribute |
| | 54 | 2 | 256 | Int | Domain |
| | 54 | 3 | 257 | PK | Primary key |
| | 54 | 4 | 258 | 53 | ID table |

Alter table client drop column no_client

| | | | | | |
|---|---|---|---|---|---|
| Deletion of an | 54 | 0 | 278 | 0 | Deletion |
| attribute | | | | | code |

Drop table client

| | | | | | |
|---|---|---|---|---|---|
| Deletion of a | 54 | 0 | 293 | 0 | Deletion |
| table | | | | | code |
| Other cases: | 54 | 3 | 308 | 22 | Update ID |
| shifting of | | | | | table |
| attribute | | | | | |

The example described above concerns a complex case without equivalence in a single SQL operation. On the other hand, an interactive management tool can allow a real benefit to be drawn from this characteristic.

As can be noted, each event that tends to modify the logical database finishes by creating one or several entries in the form of new lines (or recordings) in the journal. This guarantees that nothing is lost and that every logic deletion or updating is not translated into a physical deletion. Thus, the data of the past can be recovered. One of the advantages of this organization is the competing constitution of views such as the books of account that generally block update access by other users.

Note also the uniformity of the structure for the storage of information: The data is in fact stored in an identical manner whether the development of values or that of the structures is concerned. That is to say that from the viewpoint of logic, it is possible to reconstitute the logic tables as well as their structures on the base of one and the same mechanism. Moreover, the fact of including the journal in the same database as the main base allows the guaranteeing of its relative coherence by the transactional mechanism assured by the DBMS.

The reconstitution module (R) is in charge of reconstituting data in a logical format as a function of a parameter of the event type from the journal of events (J).

For example, consider that the application wishes to obtain the data from the client table as it was precisely at the time of event 854. This implies selecting event 854 in advance by the event cursor (C). Subsequently, the request “select * from client” is transmitted to the DBMS but transformed by the module (R) into a more complex request obtained in the following manner:

Reconstitution of the corresponding scheme: The request relates to the client table; the system must therefore verify the existence of the client table at the historical moment positioned by the target event and recover the attributes of this logic table (an optimization is possible by keeping the scheme in cache),

Recovery of the recordings whose field attribute=0 created and not deleted “before” the event corresponding to the target state (value=0 for the deletion code) and attached to this table. In the case of alternatives, “before” only concerns the events located on the same branch,

Recovery of all the recordings of which the field attribute < >0 attached to the ones preceding and previous to the target event,

Reorganization of the stream of the stored data and grouping by logical recording, that is, in our case by client.

It is possible in an embodiment of the invention to make the request for modification to past states of the main database in such a manner as to create a tree of the versions of the database processed.

In addition to values and events, the journal can collect invocations of operations. This can be realized by the representation of operations in the form of logic tables in which each operation corresponds to a logic table name and each argument corresponds to a logic attribute. By applying this correspondence scheme, the application can send to the journal (e.g., via an API (application programming interface)) the information necessary for the traceability of operation calls in a manner analogous to the manipulation of logic data (but this task can be automated and given to a post-processor, compiler, processor or even to the virtual machine.

Add (2, 8)

| Invocation of the | | | | | |
|---|---|---|---|---|---|
| operation Add with | | | | | |
| the arguments 2 and | | | | | |
| 8 | ID | Attribute | UEID | Value | Comments |
| 57 is the identifier of | 62 | 0 | 401 | 57 | ID operation |
| the operation “add” | | | | | “Add” |
| | 62 | 1 | 402 | 2 | First |
| | | | | | argument |
| 62 is the identifier of | 62 | 2 | 403 | 8 | Second |
| this invocation of the | | | | | argument |
| operation “add” | | | | | |
| | 62 | 999 | 404 | 10 | Return value |

The operation calls allow the linking of the semantics of actions of the application to the events recorded in the journal. As will be seen later, this facilitates the positioning of the cursor on the marks significant from the user's viewpoint.

In addition, the validation points of transactions can be traced in the form of operations. In fact, it is recommended that the cursor be positioned exactly on these points and not between two operations of the same transaction. The coherence of the results depends on this. On the other hand, applications such as the tools aiding in design can benefit greatly from the intermediary states, considered incoherent, for explanatory reasons and also benefit from mechanisms of the “long transactions” type.

Finally, it is specified that the operations are connected by references (not shown in the tables) to the related operations in such a manner that it is possible to also trace their membership to the execution of an operation of a higher level. It is thus possible to reconstitute the membership of operations from the elementary level of events to the level of transactions, passing as many levels of invocation as necessary for the applications.

The invention also relates to the materialization of causality links.

The stream of causal dependencies should be constituted dynamically by reading operations and updated respecting the following rules:

The manipulation of data should systematically consider along with the data read their references of origin and transport it along the stream of data and control. The application should therefore take charge of this aspect by adding to each instruction of manipulation its equivalent of the transport of references, e.g., via API. The automation of this task can be realized by a post-processor and/or by extensions of the processor or of the virtual machine.

During the insertion of physical data the references of the stream that fed it should be stored in the form of a list of elements of the ID-attribute-UEID type alongside the attribute value and this should take place for each physical recording of the journal. The following table illustrates this. An empty list would correspond to the introduction of a value from outside the system (e.g., by the entry made by a user via an interface-human machine).

| | Attri- | | | | | | |
|---|---|---|---|---|---|---|---|
| ID | bute | UEID | Value | Sources | | | Comments |
| 110 | 2 | 543 | “aaa” | | | | |
| 110 | 3 | 544 | 2 | | | | |
| 110 | 4 | 753 | “aaa2’ | ID | Attribute | UEID | The value of |
| | | | | | | | attribute 4 was |
| | | | | 110 | 2 | 543 | constituted |
| | | | | | | | from attributes |
| | | | | | | | 2 and 3 |
| | | | | 110 | 3 | 544 | |

The implementation of sources in the journal can be realized very well by an additional journal (or sub-table) organized in a tabular manner for reasons of optimization of performances according to the techniques in effect in the discipline of databases.

The interpretation of the stream is made in a simple manner: The value of a data is a function of the values of the source data read at the referenced moments by the corresponding UEID events. It can therefore be said that the sources materialize the elementary causality links.

The invocation of operations can be traced in the same manner. The following is presented by way of example: The call of the operation Add (previously mentioned) with the arguments Client.Attr3 and the constant 7.

| | Attri- | | | | | | |
|---|---|---|---|---|---|---|---|
| ID | bute | UEID | Value | Sources | | | Comments |
| 62 | 0 | 401 | 57 | | | | ID operation |
| | | | | | | | “add” |
| 62 | 1 | 402 | 2 | ID | Attribute | UEID | First |
| | | | | | | | argument |
| | | | | 110 | 3 | 543 | |

| | | | | |
|---|---|---|---|---|
| 62 | 2 | 403 | 7 | Second |
| | | | | argument |
| 62 | 999 | 404 | 10 | Return value |

The control of the validity of operations can be carried out in relation to the data in effect. For example, if the value of the attribute Attr of Client 110 changes after the execution of the operation “add”, the results sent by the latter can no longer be considered as in conformity. It is said that there is a “recovery in cause”. In the case of a development without alternatives, this can be verified by a simple comparison of UEID between the sources of the arguments and the last values of the referenced sources.

In order that this information about traceability is entirely effective for the user, it is useful to minimize the constants, that is to say the values entered “arbitrarily”. The application should therefore give special weight to systems of identification by list selection, pointing, dragging-moving, etc. or by any other technique that simultaneously improves the ergonomics of the application and implicitly allows the ensuring of a follow-up without discontinuity of the information stream. In reality, these techniques are widespread because they ensure advantages of static referencing provided in the databases in a current manner.

In addition, this characteristic of the process allows a system of automatic optimization to be put in place which, based on the systematic verification of the validity of sources, allows the result previously calculated to be returned without effectively re-executing the operation. The putting in place of such a solution implies the introduction of references to the calling operations (which can be done via supplementary arguments) and on the condition that the verification time is less than that of execution (performance statistics can be maintained by way of information and efficiently used).

The automatic notification of “recoveries in cause” can be put in place on the base of information about the validity of the data versions in relation to the streams. Thus, for an operation a class of operation, a target or a given source, beacons of coherence of stream can notify the applications by synchronous or asynchronous messages.

The re-execution consists of a new, explicit invocation of a given operation on the model of a preceding invocation but on the base of new values. In all instances it will give rise to new values for the data, the operations and the traced sources.

The process of the invention is especially designed for managing in an operational manner the historization with the current and the restoration on the fly. Moreover, the managing of storage volumes is facilitated and optimized by a number of factors:

Only the attribute values that change are stored (redundancy is therefore minimized).

The volumes necessary for supplementary storage increase in a linear manner with the number of attributes modified or deleted and do not depend on the data volumes inserted into the base. This factor allows a very advantageous use for a very broad spectrum of applications.

Finally, very pertinent purges can be made according to the data marked as recovered in cause by the traceability links of the source-destination type but this operation should be piloted by the applications as a function of the semantics of recoveries in cause.

For reasons of simplifying the discourse in the previous example we made the implicit hypothesis of a sequential organization of the events and therefore of the states of the main base (according to a total order). Thus, in order to verify the validity of the source, we evoked as solution the simple comparison of the universal event identifiers (UEID).

In reality, our process permits a vast selection of organization of versions as, e.g.:

Tree: Each event has a related event. The value of a data associated with an event can be obtained by a logical tracing back of the relatives to the closest value.

Graph oriented without circuit: Analogously to a tree, this organization permits a version to have several different relatives. The ambiguities of resolution can be eliminated by predefined rules based on criteria of the priority of the branches or on any other characteristic of the data (its type, etc.).

The development of the different branches can be merged, using the re-execution of the operations.

The virtual versions are predefined branches of events that permit the constituting of parallel configurations that can simultaneously benefit events applied to one or several branches called “of reference”. Other characteristics:

Any conflicts are avoided by the separation of events by nature into branches of reference in accordance with the model evoked in the graph organization oriented without circuit.

The materialization of these configurations is not real because the events are not duplicated physically (the propagation is logical).

The architecture implemented for realizing the invention can also comprise the following modules:

A system for the follow-up of the conformity (SC) of applications with the states of the base and of its scheme. The principle is based on the recording of a version identifier of the application in order to declare a level of compatibility with the state or states corresponding to the scheme of the main base,

Tools for automatic inoculation (I) into the applications of instructions dedicated to the follow-up of dynamic dependencies (capture of data streams): pre-post-processor or expanded virtual machine,

Visual components specialized in the navigation and exploration of the base states (not shown).

The invention can be implemented in several manners in accordance with the context in which it is integrated in an application.

FIG. 3 shows an architecture that permits three levels of integration of traceability from bottom to top:

The existing applications can continue to access the database (called “main”) in the same manner. The base can either retain its original structure and redirect the access to an associated journal (called internal base), or develop toward a physical organization of the journal type and offer views or a driver in charge of the translation of requests and results.

Existing applications can be readily provided with a “cursor” on the condition that the access to the data is centralized (which is generally the case, e.g., via a single driver). In this instance the application can offer automatic access means to the databases (now implemented in the form of a journal) and permit users to actuate a cursor that positions the readings on the desired event mark. Slight adaptations can take place in order to reconcile the granularity of the events with the semantics of the application.

New applications constructed entirely on the base of the technologies of the inoculation of the generation of traces will benefit implicitly from the most advanced level of traceability offered by this process comprising an exhaustive follow-up of the development of data and of their structure. In order that the follow-up of the development of applications is ensured at the same level, it is sufficient to return to the declarative techniques of the representation of sources, to commit them to the same journal and to have them manipulated by an assembly tool provided itself with a traceability module in accordance with this process.

This architecture permits the gradual attainment of more and more elevated levels of traceability of persistent data:

Initial: Representation and persistence (indispensable, previous), ensured by the initial persistence system

Journalization of events (useful, short-term recovery in case of breakdown but poses a problem of rapid reconstitution of past states

Historization and versioning (useful because the values stored are multiple and can comprise variants, but this functionality generates problems of reconstitution in a mode compatible with the initial mode)

Structural development: The follow-up of development of data and of the scheme of the main database, compatible with the initial mode

Causal dependence: The detection of streams of dynamic dependence and causality links between the data of the historization database (journalized).

The use of branches offers the possibility of creating alternatives of development of the database. At the same time, this raises new problems regarding the traceability. In fact, suppose that after the separation of branches A and B, data X is modified in branch A by operation O. It could then be desirable to send its new value to branch B as if it had had this value at the moment of the separation of the branches. This operation, called refreshing, is very useful for numerous instances in which institutional reference data is received at more or less regular intervals. Their integration can then pose problems of interference with the operations carried out in the meantime. For example, if no operation that had as source or destination data X in branch B was performed in the meantime, it can be considered that there is no impact. On the other hand, if that is the case, it is then necessary to decide (explicitly or implicitly) which operation has priority and to redo the others. These conflicts are readily detectable by the links of dynamic dependence. The associated semantics will be supplied by that of the operations that caused these dependencies. A simple comparison of the universal identifier of the traces of operations allows the evaluation of priority and to confirm it or cancel it. The user (or the application via a system of predefined rules) can thus decide with knowledge. The case of a merging of branches is quite analogous.

Note that this technique is more interesting than the anticipated interlocking of data since in numerous instances the operations to come cannot be foreseen and their target data even less. Moreover, the possibility of creating branches is the means intended to avoid conflicts at least temporarily and that allows their resolution to be postponed.

The virtual branches, that are by definition permanently refreshed by their “related” branches, automatically benefit from the refreshing of data in their related branches, including operations of splitting up (creation of new branches) that are preformed (virtually, of course) at the same time on the virtual branches. For example, if branch B is virtual, then every operation carried out on branch A is automatically passed onto branch B. Moreover, if a new branch A2 is created from A, this will have as effect the creation of an analogous sub-branch B2 from B. It is important to underline the virtual character of these refreshments. That is to say that in reality no processing is really carried out. The only effect is the fact that a next request on branch B will have an enriched result (that takes account of the refreshed data). Finally, note that in case of an automatic propagation there is no automatic resolution of conflict unless rules were predefined. In certain cases it can be decided in advance that, by default, that which was modified explicitly in the virtual branch still has priority over data provided by refreshment.

The merging of complex data is a case that is more sophisticated and more realistic at the same time since most often the major decision criterion of the selection of versions with a view to resolving conflict is the context. Consider that data X is a command and that the data Y1 and Y2 are two of its command lines. If a new price for article Z1 is proposed in the “related” branch, then propagated in the branch in question, it must then be decided if this calls into question the value of command X knowing that line Y1 refers precisely to article Z1. The response will be given by the management rule in force for the commands. Such a rule could be expressed, e.g., in the following form: “if the command is in the paid state, the command remains intact, otherwise, my price updates will apply at once”. Note that this rule does not have to take into account notions of version, branch or even of causal tract, which emphasizes once more the very low level of intrusion of our process.

In conclusion, the availability of causal traces allows the various merging possibilities to be more finely configured while scrupulously respecting the processes and everything by supplying the irrefutable proof in this regard.

The spectrum of applications of the invention covers the majority of cases in which it is useful to follow the development of persistent data, management applications and up to file management systems using design tools based on universal sets (or repository), or beyond the requirements of persistence if the follow-up of the development is useful.

The invention was described above by way of example. It is understood that an expert in the art is capable of realizing different variants of the invention without departing from the scope of the patent.

1-12. (canceled)

13. A process for organizing a digital database in a traceable form comprising:
modifying a main digital database by addition or deletion or modification of a recording of the main database, wherein modifying the main database comprises creating at least one digital recording comprising at least: unique digital identifiers of concerned recordings and attributes of the main database, a unique digital identifier of a state of the main database corresponding to the modification of the main database, elementary values of attributes assigned via elementary operations without proceeding to store non-modified attributes or recordings, and addition of the concerned recording in an internal historical database composed of at least one internal historical table, and
reading the main database, wherein reading relates to any final or previous state of the main database and comprises receiving or intercepting an original request associated with the unique identifier of a target state in proceeding to a transformation of an original request to construct a modified request for addressing the historical database comprising criteria of the original request and the identifier of the target state, and reconstruction of the recording or recordings corresponding to the criteria of the original request and to the target state, wherein the reconstruction comprises finding elementary values contained in the recordings of the historical database and corresponding to the criteria of the original request to reduce requirements of storage capacity and processing times.

14. The process according to claim 13, wherein the recordings of the historical database also contain references to other recordings of the internal database to specify connections of dynamic dependence of source-destination type constituting a casual stream of interferences between data versions.

15. The process according to claim 13, wherein modifying the main database is a logic operation and addition of the historical database comprises:
a recording identifying the state of the base corresponding to the logic operation,
as many recordings as parameters of the logic operation,
a recording for the possible result of the logic operation, and
specifying by cognateness regrouping of operations from the elementary level of modification to the level of the transaction, passing the number of semantic levels necessary for the applications.

16. The process according to claim 13, wherein the main database comprises one or several tables organizing development links between the identifiers of successive and alternative states of the main database and intended to organize recordings of the internal database.

17. The process according to claim 16, wherein the table or tables of the development links between the states of the main base contain(s) recordings specifying rules of correspondence between the recordings of the internal historical database and the states of the main database.

18. The process according to claim 16 or 17, wherein reading comprises determining the state of the main database by referring to the identifiers and to the tables of development links between the states of the main base.

19. An architecture for database management that employs the process according to claim 13, wherein an application querying the main database can specify the state of the desired main database.

20. The architecture according to claim 19, wherein the application brings about modifications in the entire state of the main base and gives rise, in the instance of an attempt to modify a previous state, to creation of new alternatives of digital development of the main database, whose data is generated by the same internal historical database.

21. The process according to claim 15, wherein the dependence links serve as recovery criteria for said operations already carried out.

22. The process according to claim 15, wherein updatings carried out on various branches can be integrated or merged into the framework of a new state inheriting these branches.

23. The process according to claim 15, wherein cases of the development of the structure of the data of the main database are treated as particular cases of the development of the data of the base, with the proviso that little of the structure/scheme of the main base is described in a manner cited for the data, as a dictionary.

24. The process according to claim 15, wherein the historical database is explored and queried by applications via a native mode of a DBMS to obtain information and to navigate along versions and streams of dynamic dependence in accordance with the querying language in force required by the DBMS.
